(19) United States
(12) Patent Application Publication
(10) Pub. No.: US 2006/0284799 A1
(43) Pub. Date: Dec. 21, 2006

(54) Plasma display apparatus

(75) Inventor: Jeong Pil Choi, Suwon-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/452,340

(22) Filed: Jun. 14, 2006

(30) Foreign Application Priority Data
Jun. 16, 2005 (KR) 10-2005-0052098

(51) Int. Cl. G09G 3/28

(52) U.S. Cl. 345/68

(57) ABSTRACT

A plasma display apparatus is provided. The plasma display apparatus a plasma display panel comprising an electrode, a sustain voltage circuit unit, and an energy supply/recovery circuit unit. The sustain voltage circuit unit comprises a plurality of sustain voltage circuits, which maintain a voltage of the plasma display panel at a predetermined voltage and comprise a common input terminal. The energy supply/recovery circuit unit comprises a plurality of energy supply/recovery circuits for supplying and recovering an energy to and from the plasma display panel. The plurality of energy supply/recovery circuits comprises a common output terminal and are connected to the sustain voltage circuit unit

This Non-provisional application claims priority under 35 U.S.C. §119(a) on Patent Application No. 10-2005-0052098 filed in Korea on Jun. 16, 2005 the entire contents of which are hereby incorporated by reference.

### BACKGROUND OF THE INVENTION

1. Field of the Invention

This document relates to a display apparatus, and more particularly, to a plasma display apparatus.

2. Description of the Background Art

Out of display apparatuses, a plasma display apparatus comprises a plasma display panel and a driver for driving the plasma display panel.

The plasma display panel comprises a front panel, a rear panel, and barrier ribs formed between the front panel and the rear panel. The barrier ribs form discharge cells. Each of the discharge cells is filled with an inert gas containing a main discharge gas such as neon (Ne), helium (He) or a Ne—He gas mixture and a small amount of xenon (Xe).

When a high frequency voltage generates a discharge, the inert gas within the discharge cells generates vacuum ultraviolet rays. The vacuum ultraviolet rays emit a phosphor formed between the barrier ribs such that the image is displayed. Since the above-described plasma display panel can be manufactured to be thin and light, the plasma display panel has been considered as a next generation display apparatus.

FIG. 1 illustrates a related art driving apparatus of a related art plasma display panel.

Referring to FIG. 1, a related art driving apparatus of a plasma display panel comprises a sustain circuit unit 100, a setup supply unit 110, a negative polarity scan voltage supply unit 120, a set-down supply unit 130, a scan reference voltage supply unit 140, a drive integrated circuit (IC) 150, a seventh switch Q7 connected between the setup supply unit 110 and the drive IC 150, and a sixth switch Q6 connected between the sustain circuit unit 100 and the setup supply unit 110.

The drive IC 150 is connected in the form of push-pull. The drive IC 150 comprises a twelfth switch Q12 and a thirteenth switch Q13 for receiving a voltage signal from the sustain circuit unit 100, the setup supply unit 110, the negative polarity scan voltage supply unit 120, the set-down supply unit 130, and the scan reference voltage supply unit 140.

An output line between the twelfth switch Q12 and the thirteenth switch Q13 is connected to one of plurality of scan electrodes of the plasma display panel Cp.

The sustain circuit unit 100 recovers energy from the panel Cp and supplies a sustain voltage Vs to the panel Cp.

The negative polarity scan voltage supply unit 120 supplies a scan pulse having a voltage magnitude of −Vy to the scan electrodes in an address period.

The scan reference voltage supply unit 140 supplies a scan reference voltage Vsc to the scan electrodes in the address period.

The set-down supply unit 130 supplies a falling ramp pulse to the scan electrodes in a set-down period of a reset period.

The setup supply unit 110 supplies a rising ramp pulse to the scan electrodes in a setup period of the reset period.

Generally, the plurality of sustain circuit units 100 are formed on a single board. This will be described with reference to FIG. 2.

FIG. 2 illustrates an example for integrating a plurality of sustain circuit units into one module in a related art driving apparatus of a plasma display panel.

Referring to FIG. 2, a plurality of sustain circuit units 200, 201 and 202 are formed on a single board. The plurality of sustain circuit units 200, 201 and 202 formed on the single board are commonly connected to a node n1.

The reason to form the plurality of sustain circuit units 200, 201 and 202 on the single board is that a sustain voltage Vs, which the sustain circuit units 200, 201 and 202 supply to a plasma display panel is relatively high.

For example, when only the sustain circuit unit 200 supplies all of the sustain voltage Vs, electrical components, for example, an energy storing capacitor C1, a first switch Q1, a second switch Q2, a third switch Q3, a fourth switch Q4, a first diode D1, a second diode D2 and a first inductor L1 of the sustain circuit unit 200 must have a high withstanding voltage characteristic. Consequently, the fabricating cost of the driving apparatus increases.

Further, the generation of heat and conduction resistance (Rds) in the electrical components of the sustain circuit unit 200 increase.

Accordingly, as illustrated in FIG. 2, the forming of the plurality of sustain circuit units 200, 201 and 202 on the single board decreases the generation of heat and conduction resistance (Rds) in electrical components of each of the sustain circuit units 200,201 and 202.

There is a strong likelihood that a deviation between the driving characteristics of the electrical components of the sustain circuit units 200,201 and 202 causes an electrical damage or a thermal damage of the electrical components in the related art driving apparatus of the plasma display panel of FIG. 2.

In theory, the electrical components having an equal function must have the equal driving characteristics. However, a deviation in the fabricating processes of the electrical components causes the deviation between the driving characteristics of the electrical components.

As the size of the plasma display panel becomes larger and the number of electrical components used in the driving apparatus of the plasma display panel increases, the deviation between the driving characteristics of the electrical components becomes more increasing. Accordingly, when driving the plasma display panel, there are problems such as the concentration in generation of heat, an increase in power consumption, damages of electrical components.

For example, suppose that the sustain circuit unit 200 supplies the sustain voltage Vs at a time point t0, the sustain circuit unit 201 supplies the sustain voltage Vs at a time point t1 later than the time point t0 by Δt, and the sustain circuit unit 202 supplies the sustain voltage Vs at a time point t2 later than the time point t1 by Δt.

In other words, the sustain circuit unit 200 supplies the sustain voltage Vs more rapidly than the sustain circuit units 201 and 202.

Therefore, load of the sustain voltage Vs is concentrated on the sustain circuit unit 200.

Since load of the sustain voltage Vs is concentrated on the sustain circuit unit 200, superheat is generated in the driving apparatus and the electrical components of the sustain circuit unit 200 are electrically or thermally damaged

### SUMMARY OF THE INVENTION

Accordingly, an object of the present invention is to solve at least the problems and disadvantages of the related art.

Embodiments of the present invention provides a plasma display apparatus capable of preventing the generation of heat and a damage caused by a deviation between driving characteristics in a sustain circuit unit.

According to an aspect there is provided a plasma display apparatus comprising a plasma display panel comprising an electrode, a sustain voltage circuit unit comprising a plurality of sustain voltage circuits, which maintain a voltage of the plasma display panel at a predetermined voltage and comprise a common input terminal and an energy supply/recovery circuit unit comprising a plurality of energy supply/recovery circuits for supplying and recovering an energy to and from the plasma display panel the plurality of energy supply/recovery circuits comprising a common output terminal and being connected to the sustain voltage circuit unit.

According to another aspect, there is provided a plasma display apparatus comprising a plasma display panel comprising an electrode, a sustain voltage circuit unit, in which a plurality of sustain voltage circuits for maintaining a voltage of the plasma display panel at a predetermined voltage are connected in parallel and an energy supply/recovery circuit unit, in which a plurality of energy supply/recovery circuits for supplying and recovering energy to and from the plasma display panel and being connected to the sustain voltage circuit unit are connected in parallel.

According to still another aspect there is provided a plasma display apparatus comprising a plasma display panel driven by dividing the plasma display panel into a plurality of regions, a first sustain circuit comprising a first energy supply/recovery circuit for supplying and recovering an energy to and from a first region of the plasma display panel and a first sustain voltage circuit for maintaining a voltage of the first region at a predetermined voltage, and a second sustain circuit comprising a second energy supply/recovery circuit for supplying and recovering an energy to and from a second region of the plasma display panel, and a second sustain voltage circuit for maintaining a voltage of the second region at a predetermined voltage, wherein an output terminal of the first energy supply/recovery circuit and an output terminal of the second energy supply/recovery circuit are commonly connected to each other.

### BRIEF DESCRIPTION OF THE DRAWINGS

The invention will be described in detail with reference to the following drawings in which like numerals refer to like elements.

FIG. 1 illustrates a related art driving apparatus of a plasma display panel

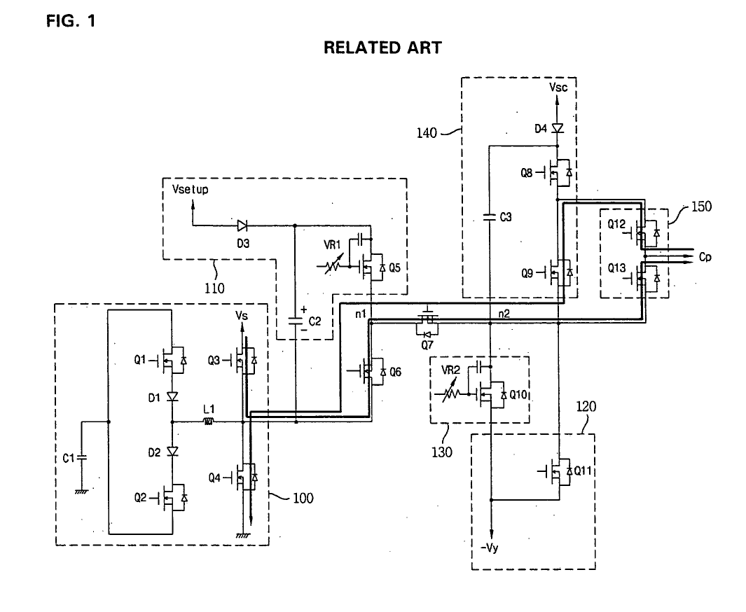

FIG. 2 illustrates an example for integrating a plurality of sustain circuit units into one module in a related art driving apparatus of a plasma display panel;

FIG. 3 illustrates a structure of a plasma display panel of a plasma display apparatus according to a first embodiment of the present invention;

FIG. 4 illustrates a method of driving the plasma display apparatus according to the first embodiment of the present invention;

FIG. 5 illustrates a structure of the plasma display apparatus according to the first embodiment of the present invention;

FIG. 6 illustrates an operation of the plasma display apparatus according to the first embodiment of the present invention; and

FIG. 7 illustrates a structure of a plasma display apparatus according to a second embodiment of the present invention.

### DETAILED DESCRIPTION OF PREFERRED EMBODIMENTS

Preferred embodiments of the present invention will be described in am ore detailed manner with reference to the drawings.

A plasma display apparatus according to embodiments of the present invention comprises a plasma display panel comprising an electrode, a sustain voltage circuit unit comprising a plurality of sustain voltage circuits, which maintain a voltage of the plasma display panel at a predetermined voltage and comprise a common input terminal, and an energy supply/recovery circuit unit comprising a plurality of energy supply/recovery circuits for supplying and recovering an energy to and from the plasma display panel the plurality of energy supply/recovery circuits comprising a common output terminal and being connected to the sustain voltage circuit unit.

The common output terminal of the energy supply/recovery circuit unit and the common input terminal of the sustain voltage circuit unit may be commonly connected to each other.

The plurality of sustain voltage circuits may comprise a common output terminal.

The energy supply/recovery circuit unit may be formed on a single board by combining the plurality of energy supply/recovery circuits.

The sustain voltage circuit unit may be formed on a plurality of boards by combining the plurality of sustain voltage circuits.

The plurality of boards equals to two.

The plurality of energy supply/recovery circuits comprises an energy storing unit comprising a capacitor, an energy supply control unit for supplying an energy stored in the energy storing unit to the plasma display panel, and an energy recovery control unit for storing a reactive energy of the plasma display panel in the energy storing unit.

The plurality of sustain voltage circuits comprise an inductor unit connected between the output terminal of the energy supply/recovery circuit unit and the plasma display panel, a sustain voltage supply unit for supplying a sustain voltage to the plasma display panel, and a ground voltage supply unit for supplying a ground level voltage to the plasma display panel.

A plasma display apparatus acceding to the embodiments of the present invention comprises a plasma display panel comprising an electrode, a sustain voltage circuit unit, in which a plurality of sustain voltage circuits for maintaining a voltage of the plasma display panel at a predetermined voltage are connected in parallel, and an energy supply/recovery circuit unit, in which a plurality of energy supply/recovery circuits for supplying and recovering energy to and from the plasma display panel and being connected to the sustain voltage circuit unit are connected in parallel.

A common output terminal of the energy supply/recovery circuit unit and a common input terminal of the sustain voltage circuit unit may be commonly connected to each other.

The plurality of sustain voltage circuits may comprise a common output terminal.

The energy supply/recovery circuit unit may be formed on a single board by combining the plurality of energy supply/recovery circuits.

The sustain voltage circuit unit may be formed on a plurality of boards by combining the plurality of sustain voltage circuits.

The plurality of boards equals to two.

The plurality of energy supply/recovery circuits comprises an energy storing unit comprising a capacitor, an energy supply control unit for supplying energy stored in the energy storing unit to the plasma display panel, and an energy recovery control unit for storing a reactive energy of the plasma display panel in the energy storing unit.

The plurality of sustain voltage circuits comprise an inductor unit connected between the output terminal of the energy supply/recovery circuit and the plasma display panel a sustain voltage supply unit for supplying a sustain voltage to the plasma display panel and a ground voltage supply unit for supplying a ground level voltage to the plasma display panel.

A plasma display apparatus according to the embodiments of the present invention comprises a plasma display panel driven by dividing the plasma display panel into a plurality of regions, a first sustain circuit comprising a first energy supply/recovery circuit for supplying and recovering an energy to and from a first region of the plasma display panel and a first sustain voltage circuit for maintaining a voltage of the first region at a predetermined voltage, and a second sustain circuit comprising a second energy supply/recovery circuit for supplying and recovering an energy to and from a second region of the plasma display panel and a second sustain voltage circuit for maintaining a voltage of the second region at a predetermined voltage, wherein an output terminal of the first energy supply/recovery circuit and an output terminal of the second energy supply/recovery circuit are commonly connected to each other.

The switching timing of the first sustain circuit may be controlled by a first timing controller, and switching timing of the second sustain circuit is controlled by a second timing controller.

The first energy supply/recovery circuit may comprise a first energy storing unit comprising a capacitor, a first energy supply control unit for supplying an energy stored in the first energy storing unit to the first region, and a first energy recovery control unit for storing a reactive energy of the first region in the first energy storing unit.

The first sustain voltage circuit comprises a first inductor unit connected between the output terminal of the first energy supply/recovery circuit and the first region, a first sustain voltage supply unit for supplying a sustain voltage to the first region, and a first ground voltage supply unit for supplying a ground level voltage to the first region.

The second energy supply/recovery circuit comprises a second energy storing unit comprising a capacitor, a second energy supply control unit for supplying an energy stored in the second energy storing unit to the second region, and a second energy recovery control unit for storing a reactive energy of the second region in the second energy storing unit.

The second sustain voltage circuit comprises a second inductor unit which is connected between the output terminal of the second energy supply/recovery circuit and the second region, a second sustain voltage supply unit for supplying a sustain voltage to the second region, and a second ground voltage supply unit for supplying a ground level voltage to the second region.

Hereinafter, exemplary embodiments of the present invention will be described in detail with reference to the attached drawings.

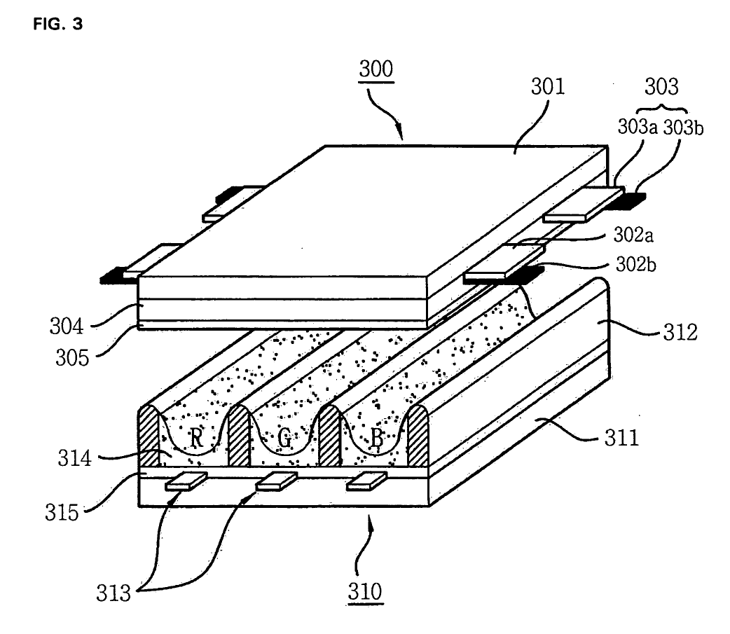

FIG. 3 illustrates a structure of a plasma display panel of a plasma display apparatus according to a first embodiment of the present invention.

As illustrated in FIG. 3, the plasma display panel comprises a front panel 300 and a rear panel 310 which are coupled in parallel to oppose to each other at a given distance therebetween A plurality of scan electrodes 302 and a plurality of sustain electrodes 303 are formed in pairs on a front glass substrate 301 of the front panel 310 being a display surface, on which an image is displayed, to form a plurality of maintenance electrode pairs. A plurality of address electrodes 313 are arranged on a rear glass substrate 311 of the rear panel 310 constituting a rear surface to intersect the plurality of maintenance electrode pairs.

The scan electrode 302 and the sustain electrode 303 each comprise transparent electrodes 302a and 303a made of transparent indium-oxide (ITO) material and bus electrodes 302b and 303b made of a metal material. The scan electrode 302 and the sustain electrode 303 generate a mutual discharge therebetween one discharge cell and maintain emissions of discharge cells.

The scan electrode 302 and the sustain electrode 303 are covered with one or more upper dielectric layers 304 for limiting a discharge current and providing insulation between the maintenance electrode pairs. A protective layer 305 with a deposit of MgO is formed on an upper surface of the upper dielectric layer 304 to facilitate discharge conditions.

A plurality of stripe-type (or well-type) barrier ribs 312 are formed in parallel on the rear glass substrate 311 of the rear panel 310 to form a plurality of discharge spaces, that is, a plurality of discharge cells. The plurality of address electrodes 313 are arranged in parallel with the barrier ribs 312 to perform an address discharge and generate vacuum ultraviolet rays.

Red (R), green(G) and blue (B) phosphors 314 are coated on an upper surface of the rear glass substrate 311 to emit visible light for displaying an image during the generation of the address discharge. A lower dielectric layer 315 is formed between the address electrodes 313 and the phosphors 314 to protect the address electrodes 313.

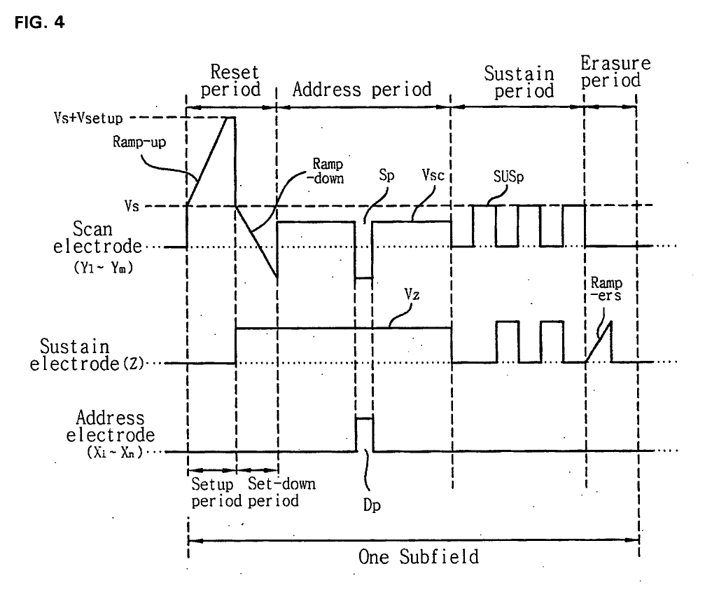

To drive the plasma display panel having the above-described structure, a method of driving the plasma display apparatus acceding to the first embodiment of the present invention will be described with reference to FIG. 4.

FIG. 4 illustrates a method of driving the plasma display apparatus acceding to the first embodiment of the present invention.

As illustrated in FIG. 4, the plasma display panel is driven by dividing each of subfields into a reset period for initializing all cells, an address period for selecting cells to be discharged, a sustain period for maintaining discharges of the selected cells, and an erasure period for erasing wall charges within the discharged cells.

In the reset period, a rising ramp waveform Ramp-up is simultaneously supplied to an scan electrodes Y1 to Ym during a setup period. The rising ramp waveform Ramp-up generates a weak dark discharge within the discharge cells of the entire screen. The weak dark discharge is called a setup discharge.

By performing the setup discharge, positive wall charges are accumulated on address electrodes X1 to Xn and sustain electrodes Z, and negative wall charges are accumulated on the scan electrodes Y1 to Ym.

In a set-down period of the reset period, a falling ramp waveform Ramp-down, which falls from a positive voltage lower than a peak voltage of the rising ramp waveform to a specific voltage of a ground level voltage GND or less, is supplied to the scan electrodes Y1 to Ym to generate a weak erasure discharge within the cells. The weak erase discharge sufficiently erases the wall charges excessively accumulated on the scan electrodes Y1 to Ym. The weak erase discharge is called a set-down discharge.

By performing the set-down discharge, the wall charges uniformly remain within the cells to the degree that there is the generation of a stable address discharge.

In the address period, a negative polarity scan pulse Sp is sequentially supplied to the scan electrodes Y1 to Ym and, at the same time, a positive polarity data pulse Dp synchronized with the scan pulse Sp is supplied to the address electrodes X1 to Xn.

While the voltage difference between the negative polarity scan pulse Sp and the positive polarity data pulse Dp is added to the wall charges produced during the reset period, the address discharge is generated within the discharge cells to which the data pulse Dp is supplied.

The wall charges necessary for a sustain discharge when supplying a sustain voltage Vs are formed within the cells selected by performing the address discharge.

A positive voltage Vz is supplied to the sustain electrodes Z during the set-down period and the address period to decrease the voltage difference between the sustain electrodes Z and the scan electrodes Y1 to Ym. Accordingly, an erroneous discharge between the sustain electrodes Z and the scan electrodes Y1 to Ym is prevented.

In the sustain period, a sustain pulse SUSp is alternately supplied to the scan electrodes Y1 to Ym and the sustain electrodes Z.

While the wall voltage within the cells selected by performing the address discharge is added to the sustain pulse SUSp, a sustain discharge, that is, a display discharge, is generated between the scan electrodes Y1 to Ym and the sustain electrodes Z whenever the sustain pulse SUSp is supplied.

After completing the sustain discharge, in the erasure period, an erasure ramp waveform Ramp-ers with a narrower pulse width and a low level voltage is supplied to the sustain electrodes Z to erase the wall charges remaining within the cells of the whole screen.

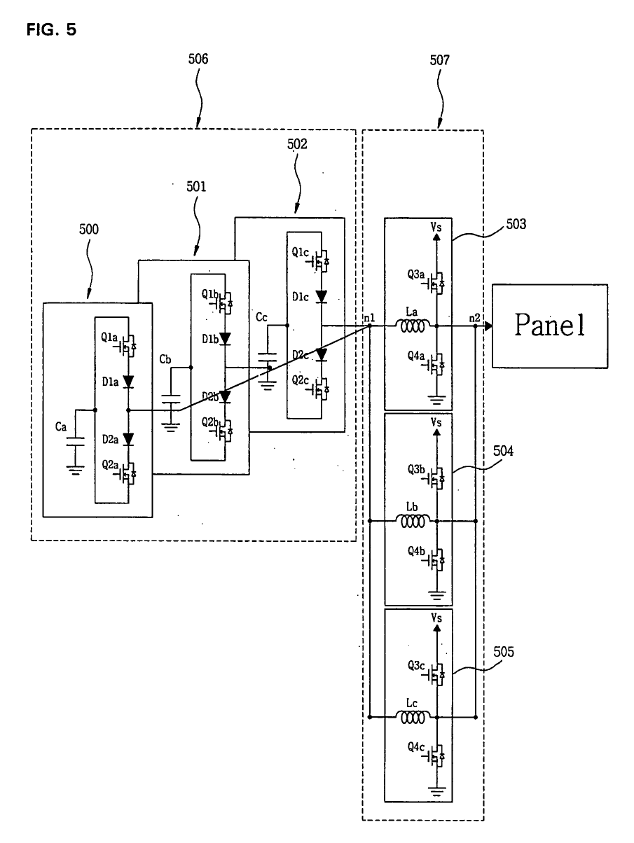

FIG. 5 illustrates a structure of the plasma display apparatus acceding to the first embodiment of the present invention.

As illustrated in FIG. 5, the plasma display apparatus according to the first embodiment of the present invention comprises an energy supply/recovery circuit unit 506 comprising a plurality of energy supply/recovery circuits 500, 501 and 502, and a sustain voltage circuit unit 507 comprising a plurality of sustain voltage circuits 503, 504 and 505.

The energy supply/recovery circuit unit 506 and the sustain voltage circuit unit 507 form a sustain circuit (not shown).

The energy supply/recovery circuits 500, 501 and 502 supply an energy to the plasma display panel and recover a reactive energy from the plasma display panel.

The energy supply/recovery circuits 500, 501 and 502 of the energy supply/recovery circuit unit 506 are commonly connected to a first node n1 as an output terminal. Therefore, the energy supply/recovery circuit unit 506 has the first node n1 as the output terminal.

In other words, the energy supply/recovery circuits 500, 501 and 502 are connected in parallel

The plurality of sustain voltage circuits 503,504 and 505 maintain a voltage of the plasma display panel at a predetermined voltage.

For example, the plurality of sustain voltage circuits 503, 504 and 505 maintain a voltage of the plasma display panel at a sustain voltage Vs or a ground level voltage GND for a predetermined duration of time.

Input terminals of the plurality of sustain voltage circuits 503, 504 and 505 are commonly connected to the output terminal n1 of the energy supply/recovery circuit unit 506.

The plurality of sustain voltage circuits 503,504 and 505 of the sustain voltage circuit unit 507 are commonly connected to a second node n2 as an output terminal. Therefore, the sustain voltage circuit unit 507 has the second node n2 as the output terminal.

In other words, the plurality of sustain voltage circuits 503, 504 and 505 are connected in parallel.

It is preferable that the plurality of energy supply/recovery circuits 500,501 and 502 of the energy supply/recovery circuit unit 506 are integrated one another and are formed on a single board.

The plurality of sustain voltage circuits 503,504 and 505 of the sustain voltage circuit unit 507 may be integrated one another and may be formed on a plurality of boards.

Preferably, the plurality of sustain voltage circuits 503, 504 and 505 are formed on two boards.

In the plasma display apparatus according to the first embodiment of the present invention, the energy supply/recovery circuit unit 506 and the sustain voltage circuit unit 507 of the sustain circuit unit are formed on different boards. Accordingly, although electrical components of the plasma display apparatus according to the first embodiment of the present invention have different driving characteristics, an electrical damage or a terminal damage of the electrical components caused by a deviation between the different driving characteristics is prevented.

Characteristics of the plasma display apparatus according to the first embodiment of the present invention will be described with reference to a description of an operation of the plasma display apparatus according to the first embodiment of the present invention.

The plurality of energy supply/recovery circuits 500, 501 and 502 of the energy supply/recovery circuit unit 506 each comprise an energy storing unit, energy supply control units Q1a, Q1b and Q1c, energy recovery control units Q2a, Q2b and Q2c, first diodes D1a , D1b and D1c, second diodes D2a, D2b and D2c.

The energy storing unit comprises energy storing capacitors Ca, Cb and Cc.

The energy storing capacitors Ca, Cb and Cc recover and store the reactive energy of the plasma display panel.

The energy supply control units Q1a, Q1b and Q1c are turned on in an energy supply period such that the energy stored in the energy storing unit is supplied to the plasma display panel.

The energy recovery control units Q2a, Q2b and Q2c are turned on in an energy recovery period such that the reactive energy of the plasma display panel is stored in the energy storing unit.

The plurality of sustain voltage circuits 503,504 and 505 of the sustain voltage circuit unit 507 each comprise inductor units La, Lb and Lc, sustain voltage supply units Q3a, Q3b and Q3c, and ground voltage supply units Q4a, Q4b and Q4c.

The inductor units La, Lb and Lc are connected between the output terminal n1 of the energy supply/recovery circuit unit 506 and the plasma display panel.

The sustain voltage supply units Q3a, Q3b and Q3c supply the sustain voltage Vs supplied from a sustain voltage source to the plasma display panel in a sustain voltage maintenance period.

The ground voltage supply units Q4a, Q4b and Q4c supply the ground level voltage GND supplied from a ground voltage source to the plasma display panel in a ground voltage maintenance period.

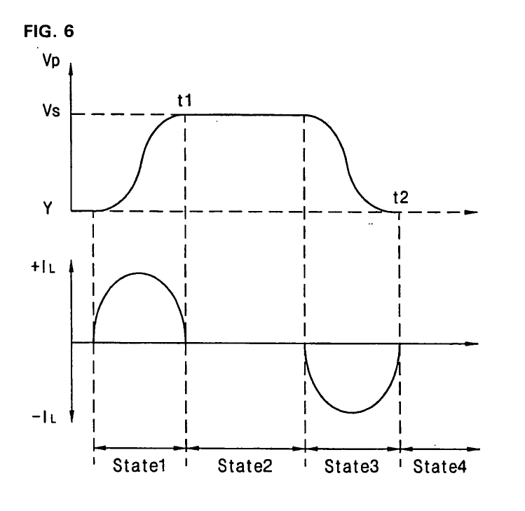

An operation of the sustain circuit comprising the energy supply/recovery circuit unit 506 and the sustain voltage circuit unit 507 will be described with reference to FIG. 6.

FIG. 6 illustrates an operation of the plasma display apparatus according to the first embodiment of the present invention.

Suppose that a voltage of Vs/2 is charged to the energy storing capacitors Ca, Cb and Cc.

When the energy supply control units Q1a, Q1b and Q1c are turned on in the energy supply period (state 1), the voltage charged to the energy storing capacitors Ca, Cb and Cc is supplied to the first node n1 through the energy supply control units Q1a, Q1b and Q1c and the first diodes D1a , D1b and D1c.

In other words, a sum of a voltage stored in the energy storing capacitor Ca of the energy supply/recovery circuit 500, a voltage stored in the energy storing capacitor Cb of the energy supply/recovery circuit 501, and a voltage stored in the energy storing capacitor Cc of the energy supply/recovery circuit 502 is supplied to the first node n1.

The voltage supplied to the first node n1 is distributed into the inductor units La, Lb and Lc of the sustain voltage circuits 503, 504 and 505

The voltage distributed into the inductor units La, Lb and Lc is supplied to the plasma display panel through the second node n2 by LC resonance between capacitance of the discharge cells of the plasma display panel and inductance of the inductor units La, Lb and Lc.

A voltage Vp of the plasma display panel rises up to the sustain voltage Vs as illustrated in State 1 of FIG. 6. Further, a current flowing in the inductor units La, Lb and Lc equals +I_{L}, since the energy is supplied from the energy storing capacitors Ca, Cb and Cc to the plasma display panel.

Next, the sustain voltage supply units Q3a, Q3b and Q3c of the sustain voltage circuits 503, 504 and 505 are turned on in the sustain voltage maintenance period (state 2).

As a result, the sustain voltage Vs supplied from the sustain voltage source is supplied to the plasma display panel through the sustain voltage supply units Q3a, Q3b and Q3c and the second node n2.

Therefore, the voltage Vp of the plasma display panel is maintained at the sustain voltage Vs as illustrated in state 2 of FIG. 6 such that the sustain discharge is generated in the plasma display panel.

Since a current does not flow in the inductor units La, Lb and Lc of the sustain voltage circuits 503, 504 and 505, the current flowing in the inductor units La, Lb and Lc equals to 0 in theory.

The energy recovery control units Q2a, Q2b and Q2c of the energy supply/recovery circuits 500, 501 and 502 are turned on in the energy recovery period (state 3) subsequent to the sustain voltage maintenance period (state 2).

Therefore, the reactive energy of the plasma display panel with a voltage component is stored in the energy storing capacitors Ca, Cb and Cc through the second node n2, the inductor units La, Lb and Lc, the first node n1, the second diodes D2a, D2b and D2c, and the energy recovery control units Q2a, Q2b and Q2c.

As a result, the voltage Vp of the plasma display panel falls from the sustain voltage Vs to the ground level voltage GND as illustrated in state 3 of FIG. 6. Further, a current flowing in the inductor units La, Lb and Lc equals −I_{L}, since the energy is supplied from the plasma display panel to the energy storing capacitors Ca, Cb and Cc.

The ground voltage supply units Q4a, Q4b and Q4c of the sustain voltage circuits 503, 504 and 505 are turned on in the ground voltage maintenance period (state 4). Therefore, the ground level voltage GND supplied form the ground voltage source is supplied to the plasma display panel through the ground voltage supply units Q4a, Q4b and Q4c and the second node n2.

The voltage Vp of the plasma display panel is maintained at the ground level voltage GND as illustrated in state 4 of FIG. 6. Since a current does not flow in the inductor units La, Lb and Lc of the sustain voltage circuits 503, 504 and 505, the current flowing in the inductor units La, Lb and Lc equals to 0 in theory.

The plurality of energy supply/recovery circuits 500, 501 and 502 are formed on the single board.

The energy supply/recovery circuits 500, 501 and 502 have the first node n1 as the common output terminal. Accordingly, although the driving characteristics of the energy supply control units Q1a, Q1b and Q1c of the energy supply/recovery circuits 500, 501 and 502 differ from one another, a maximum magnitude of the load in one electrical component that is, one of the energy supply control units Q1a, Q1b and Q1c is limited to the total voltage supplied by the energy storing capacitors Ca, Cb and Cc.

For example, suppose that the energy supply control unit Q1a of the energy supply/recovery circuit 500 is turned on at a time point t0, the energy supply control unit Q1b of the energy supply/recovery circuit 501 is turned on at a time point t1 later than the time point t0 by Δt, and the energy supply control unit Q1c of the energy supply/recovery circuit 502 is turned on at a time point t2 later than the time point t1 by Δt.

In other words, the energy supply control unit Q1a is turned on more rapidly than the energy supply control units Q1b and Q1c.

Therefore, only the total load of the energy storing capacitors Ca, Cb and Cc is loaded with the energy supply control unit Q1a.

In other words, a maximum magnitude of the load received to one electrical component is less than the related art driving apparatus.

The energy supply/recovery circuit unit 506 comprising the energy supply/recovery circuits 500, 501 and 502 is formed on the single board and outputs a result to one output terminal, that is, the first node n1. Accordingly, although the driving deviation between the electrical components of the energy supply/recovery circuits 500, 501 and 502 is generated, the energy supply/recovery circuit unit 506 outputs the approximately regular result to the first node n1.

Therefore, the sustain voltage circuit unit 507 receives a stable input signal through the first node n1 of the energy supply/recovery circuit unit 506, irrespective of the driving deviation between the electrical components of the energy supply/recovery circuit unit 506.

Further, although the driving deviation between the electrical components of the sustain voltage circuits 503,504 and 505 commonly connected to the energy supply/recovery circuits 500, 501 and 502 is generated, the sustain voltage circuits 503, 504 and 505 are driven more stably than the related art driving apparatus.

In other words, the sustain voltage circuits 503, 504 and 505 are formed on the plurality of boards, and have the common input terminal n1 and the common output terminal n2. Therefore, although the driving characteristics of the electrical components of the energy supply/recovery circuits 500, 501 and 502 differ from one another, the maximum magnitude of the load of one electrical component is less than the related art driving apparatus.

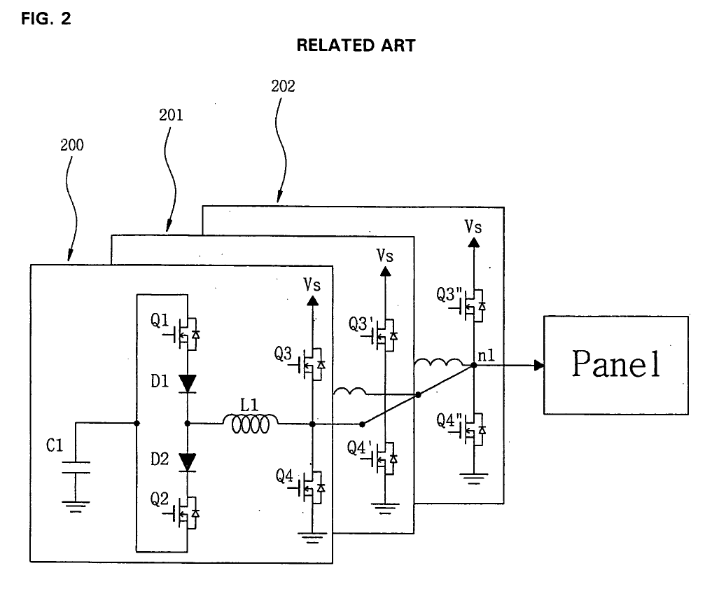

More specifically, when there is the driving deviation between the electrical components of the related art driving apparatus of the plasma display panel of FIG. 2, superheat is generated in the electrical component or the electrical component is damaged For example, when in switches Q3, Q3′ and Q3″ of the sustain circuit units 100, 101 and 102 connected to the sustain voltage source for supplying the sustain voltage Vs, a turn-on time point of the switch Q3 is earlier than turn-on time points of the switches Q3′ and Q3″, a sum of the total cumulative driving deviation of each of the sustain circuit units 100, 101 and 102 is loaded with the switch Q3. Therefore, superheat is generated in the switch Q3 or the switch Q3 is damaged

However, in the embodiment of the present invention, when there is the driving deviation between the electrical components, for example, when a turn-on time point of the sustain voltage supply unit Q3a is earlier than turn-on time points of the sustain voltage supply units Q3b and Q3c, a sum of driving deviation of each of the sustain voltage circuits 503, 504 and 505 is loaded with the sustain voltage supply units Q3a.

In other words, since the energy supply/recovery circuits 500, 501 and 502 commonly output to the first node n1, the driving deviation caused by the electrical components of the energy supply/recovery circuit unit 506 among all of the electrical components of the driving apparatus is compensated.

Since a signal for compensating the driving deviation between the electrical components of the energy supply/recovery circuit unit 506 is supplied to the sustain voltage circuit unit 507 as an input signal, a maximum magnitude of load for the electrical components of the sustain voltage circuit unit 507 is limited to the cumulative driving deviation of the electrical components of the sustain voltage circuit unit 507.

Accordingly, in the driving apparatus of the present invention, the maximum magnitude of load for the plurality of electrical components is less than the related art driving apparatus. Further, load for the plurality of electrical components is distributed. Therefore, the problems such as the concentration in generation of heat, an increase in power consumption, an electrical damage or a thermal damage of electrical components are improved.

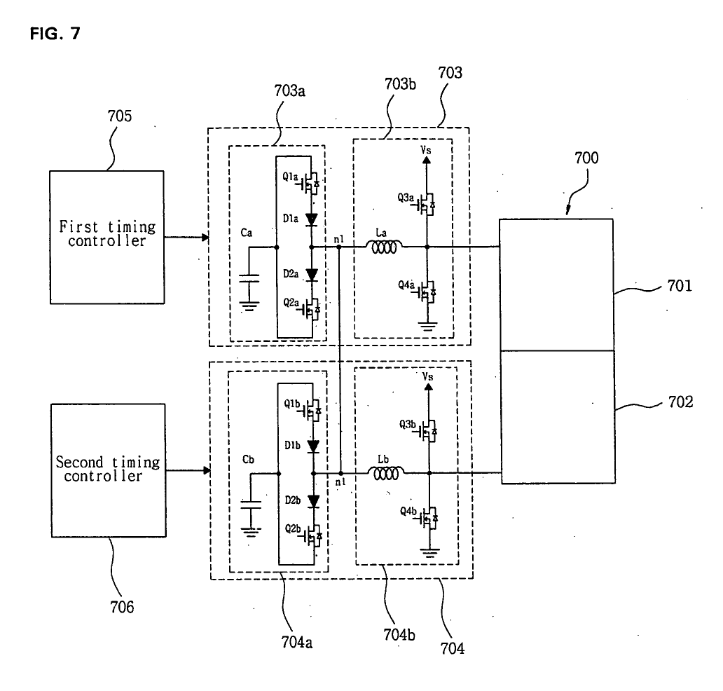

FIG. 7 illustrates a structure of a plasma display apparatus according to a second embodiment of the present invention.

Referring to FIG. 7, a plasma display apparatus according to a second embodiment of the present invention comprises a plurality of sustain circuits 703 and 704 which correspond to different regions of a plasma display panel 700, respectively.

For example, the first sustain circuit 703 corresponds to a first region 701 of the plasma display panel 700, and the second sustain circuit 704 corresponds to a second region 702 of the plasma display panel 700.

In other words, the first sustain circuit 703 supplies a sustain voltage Vs to discharge cells included in the first region 701 of the plasma display panel 700. Further, the first sustain circuit 703 recovers a reactive energy from the discharge cells in an energy recovery period.

The second sustain circuit 704 supplies a sustain voltage Vs to discharge cells included in the second region 702 of the plasma display panel 700. Further, the second sustain circuit 704 recovers a reactive energy from the discharge cells in an energy recovery period.

The plasma display panel 700 is divided into two regions in FIG. 7. However, the plasma display panel 700 may be divided into three or more regions.

Since the sustain circuits 703 and 704 drive the different regions of the plasma display panel 700, a maximum magnitude of load of one electrical component decreases.

The sustain circuits 703 and 704 each comprise first and second energy supply/recovery circuits 703a and 704a and first and second sustain voltage circuits 703b and 704b. The first and second energy supply/recovery circuits 703a and 704a supply the energy to the plasma display panel 700 and recover the reactive energy from the plasma display panel 700. The first and second sustain voltage circuits 703b and 704b maintain a voltage of the plasma display panel 700 at a predetermined voltage.

It is preferable that output terminals of the first and second energy supply/recovery circuits 703a and 704a are commonly connected to each other.

In the same way as the plasma display apparatus according to the first embodiment of the present invention, the plasma display apparatus according to the second embodiment of the present invention prevents the driving deviation generated in electrical components of the first and second energy supply/recovery circuits 703a and 704a from affecting the first and second sustain voltage circuits 703b and 704b. Accordingly, a maximum magnitude of load for one electrical component decreases.

Further, the problems such as the concentration in generation of heat an increase in power consumption, an electrical damage or a thermal damage of electrical components are improved.

It is preferable that switching timing of the sustain circuits 703 and 704 is controlled by different timing controllers 705 and 706.

For example, the switching timing of the first sustain circuit 703 for driving the first region 701 of the plasma display panel 700 is controlled by the first timing controllers 705. The switching timing of the second sustain circuit 704 for driving the second region 702 of the plasma display panel 700 is controlled by the second timing controllers 706.

The energy supply/recovery circuits 703a and 704a comprise energy storing units comprising energy storing capacitors Ca and Cb, and energy supply control units Q1a and Q1b. The energy supply control units Q1a and Q1b are turned on in an energy supply period to supply an energy stored in the energy storing units to the plasma display panel 700.

Further, the energy supply/recovery circuits 703a and 704a comprise energy recovery control units Q2a and Q2b, first diodes D1a and D1b, second diodes D2a and D2b. The energy recovery control units Q2a and Q2b are turned on in an energy recovery period such that a reactive energy of the plasma display panel 700 is stored in the energy storing unit.

The first and second sustain voltage circuits 703b and 704b comprise first and second inductor units La and Lb connected between a common output terminal, that is, a first node n1 of the first and second energy supply/recovery circuits 703a and 704a and the first and second regions 701 and 702 of the plasma display panel 700.

The first and second sustain voltage circuits 703b and 704b comprise first and second sustain voltage supply units Q3a and Q3b and first and second ground voltage supply units Q4a and Q4b. The sustain voltage supply units Q3a and Q3b supply the sustain voltage Vs supplied from a sustain voltage source in a sustain voltage maintenance period to the first and second regions 701 and 702 of the plasma display panel 700. The first and second ground voltage supply units Q4a and Q4b supply the ground level voltage GND supplied from a ground voltage source in a ground voltage maintenance period to the first and second regions 701 and 702 of the plasma display panel 700.

Since operations of the plasma display apparatus according to the second embodiment of the present invention is substantially the same as the operations of the plasma display apparatus according to the first embodiment of the present invention, a description thereof is omitted.

In the plasma display apparatus according to the second embodiment of the present invention, the problems such as the concentration in generation of heat an increase in power consumption, an electrical damage or a terminal damage of electrical components are improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising an electrode;
a sustain voltage circuit unit comprising a plurality of sustain voltage circuits, which maintain a voltage of the plasma display panel at a predetermined voltage and comprise a common input terminal; and
an energy supply/recovery circuit unit comprising a plurality of energy supply/recovery circuits for supplying and recovering an energy to and from the plasma display panel, the plurality of energy supply/recovery circuits comprising a common output terminal and being connected to the sustain voltage circuit unit.

2. The plasma display apparatus of claim 1, wherein the common output terminal of the energy supply/recovery circuit unit and the common input terminal of the sustain voltage circuit unit are commonly connected to each other.

3. The plasma display apparatus of claim 1, wherein the plurality of sustain voltage circuits comprise a common output terminal.

4. The plasma display apparatus of claim 1, wherein the energy supply/recovery circuit unit is formed on a single board by combining the plurality of energy supply/recovery circuits.

5. The plasma display apparatus of claim 1, wherein the sustain voltage circuit unit is formed on a plurality of boards by combining the plurality of sustain voltage circuits.

6. The plasma display apparatus of claim 5, wherein the plurality of boards equals to two.

7. The plasma display apparatus of claim 1, wherein the plurality of energy supply/recovery circuits comprises
an energy storing unit comprising a capacitor,
an energy supply control unit for supplying an energy stored in the energy storing unit to the plasma display panel, and
an energy recovery control unit for storing a reactive energy of the plasma display panel in the energy storing unit.

8. The plasma display apparatus of claim 1, wherein the plurality of sustain voltage circuits comprise
an inductor unit connected between the output terminal of the energy supply/recovery circuit unit and the plasma display panel,
a sustain voltage supply unit for supplying a sustain voltage to the plasma display panel, and
a ground voltage supply unit for supplying a ground level voltage to the plasma display panel.

9. A plasma display apparatus comprising:
a plasma display panel comprising an electrode;
a sustain voltage circuit unit, in which a plurality of sustain voltage circuits for maintaining a voltage of the plasma display panel at a predetermined voltage are connected in parallel; and
an energy supply/recovery circuit unit, in which a plurality of energy supply/recovery circuits for supplying and recovering energy to and from the plasma display panel and being connected to the sustain voltage circuit unit are connected in parallel.

10. The plasma display apparatus of claim 9, wherein a common output terminal of the energy supply/recovery circuit unit and a common input terminal of the sustain voltage circuit unit are commonly connected to each other.

11. The plasma display apparatus of claim 9, wherein the plurality of sustain voltage circuits comprise a common output terminal.

12. The plasma display apparatus of claim 9, wherein the energy supply/recovery circuit unit is formed on a single board by combining the plurality of energy supply/recovery circuits.

13. The plasma display apparatus of claim 9, wherein the plurality of energy supply/recovery circuits comprises
an energy storing unit comprising a capacitor,
an energy supply control unit for supplying energy stored in the energy storing unit to the plasma display panel and
an energy recovery control unit for storing a reactive energy of the plasma display panel in the energy storing unit.

14. The plasma display apparatus of claim 9, wherein the plurality of sustain voltage circuits comprise
an inductor unit connected between the output terminal of the energy supply/recovery circuit and the plasma display panel,
a sustain voltage supply unit for supplying a sustain voltage to the plasma display panel and
a ground voltage supply unit for supplying a ground level voltage to the plasma display panel.

15. A plasma display apparatus comprising:
a plasma display panel driven by dividing the plasma display panel into a plurality of regions;
a first sustain circuit comprising a first energy supply/recovery circuit for supplying and recovering an energy to and from a first region of the plasma display panel, and a first sustain voltage circuit for maintaining a voltage of the first region at a predetermined voltage; and
a second sustain circuit comprising a second energy supply/recovery circuit for supplying and recovering an energy to and from a second region of the plasma display panel, and a second sustain voltage circuit for maintaining a voltage of the second region at a predetermined voltage,
wherein an output terminal of the first energy supply/recovery circuit and an output terminal of the second energy supply/recovery circuit are commonly connected to each other.

16. The plasma display apparatus of claim 15, wherein switching timing of the first sustain circuit is controlled by a first timing controller, and switching timing of the second sustain circuit is controlled by a second timing controller.

17. The plasma display apparatus of claim 15, wherein the first energy supply/recovery circuit comprises
a first energy storing unit comprising a capacitor,
a first energy supply control unit for supplying an energy stored in the first energy storing unit to the first region, and
a first energy recovery control unit for storing a reactive energy of the first region in the first energy storing unit.

18. The plasma display apparatus of claim 15, wherein the first sustain voltage circuit comprises
a first inductor unit connected between the output terminal of the first energy supply/recovery circuit and the first region,
a first sustain voltage supply unit for supplying a sustain voltage to the first region, and
a first ground voltage supply unit for supplying a ground level voltage to the first region.

19. The plasma display apparatus of claim 15, wherein the second energy supply/recovery circuit comprises
a second energy storing unit comprising a capacitor,
a second energy supply control unit for supplying an energy stored in the second energy storing unit to the second region, and
a second energy recovery control unit for storing a reactive energy of the second region in the second energy storing unit.

20. The plasma display apparatus of claim 15, wherein the second sustain voltage circuit comprises
a second inductor unit which is connected between the output terminal of the second energy supply/recovery circuit and the second region,
a second sustain voltage supply unit for supplying a sustain voltage to the second region, and
a second ground voltage supply unit for supplying a ground level voltage to the second region.
